(19) United States
(12) Patent Application Publication
(10) Pub. No.: US 2018/0159718 A1
(43) Pub. Date: Jun. 7, 2018

(54) Computer and method of operation of its network

(71) Applicants: Sergei Makaveev, Toronto (CA); Pavel Makaveev, Toronto (CA); Mikalai Putseyeu, Vitebsk (BY); Uladzimir Putseyeu, Vitebsk (BY)

(72) Inventors: Sergei Makaveev, Toronto (CA); Pavel Makaveev, Toronto (CA); Mikalai Putseyeu, Vitebsk (BY); Uladzimir Putseyeu, Vitebsk (BY)

(21) Appl. No.: 15/810,095

(22) Filed: Nov. 12, 2017

Related U.S. Application Data
(63) Continuation of application No. 13/531,573, filed on Jun. 24, 2012.

(51) Int. Cl. H04L 12/24; H04L 29/06

(52) U.S. Cl. CPC H04L 41/00; H04L 2463/103; H04L 63/10

(57) ABSTRACT

Personal computer contains information input, output, storage, processing units, network devices, as well as pre-installed software. All units are executed stationary or mobile and in addition, each unit is supplied with devices and software such that each unit independently has the ability to log on to the network, for example through assigning the IP addresses on the Internet or number of mobile communication to each unit. Connection of units with each other may be done with cable, wireless devices or through a network between themselves only in any combination of units and any number of units. Combination of units can register IP address of units in the network at the user's option or at least one shared IP address is registered online. Interacting via IP addresses over the network the units or combination of units generate personal computer with network, with the ability to work in a network with the network -generated computer via assigning IP address that does not match IP addresses of units. In mobile use: possibility of stationary PC, uptime input/output units without recharging, the security of information.

### CROSS REFERENCE TO RELATED APPLICATIONS

“This is a continuation of application of application Ser. No. 13/531,573, filed Jun. 24, 2012.”

### THE AREA THAT THE INVENTION RELATES

Aspects of the invention relate to a personal computer device, properties of additional software for information input, output, storage, processing units, network devices. Interaction of computer units with the network prior to the commencement of the operation of a computer is offered. The establishment of a computer with network has been enhanced to provide user capabilities of modern PCs, inaccessible modern mobile devices-tablets, laptops, etc. in mobile mode.

If there is network, such as the Internet, the user is given the opportunity to use the computer units that have already been registered in the network without resorting to third—party devices and third-party software over the network. The user can use the full volumes of stored information, stationary network of power supply for storage units, information processing units, network devices. Only information input/output units are used in mobile mode.

This increases the possibilities of the computer and the ease of its use. It decreases the risk of loss of computer and need to store information from third parties, without the risk of unauthorized disclosure.

### Prior art

System “Computer's hardware—Software—Network” usually uses stationary system unit of a computer with input/output devices, storing and data processing, network connection, preinstalled operating system and applications. Through the network computer can update software, process, exchange and store information, communicate and use other devices on a network.

Following patents and claims provide different variation of installation and updating of application on the PC through cloud service such as Google.

In Patents and applications U.S. Pat. No. 7,024,427 (B2) Virtual file system EMC CORP Apr. 4, 2006;
U.S. Pat. No. 6,922,813 (B1) Page prerequisite control mechanism TRADE E Jul. 26, 2005;
U.S. Pat. No. 6,185,733 (B1) Method and apparatus for remote object code inclusion IBM Feb. 6, 2001
U.S. Pat. No. 5,809,329 (A) System for managing the configuration of a computer system MICROSOFT CORP Sep. 15, 1998;
U.S. Pat. No. 5,778,226 (A) Kernels, description tables and device drivers IOMEGA CORP Jul. 7, 1998;
U.S. Pat. No. 4,974,151 (A) Configuration capability for devices in an open system having the capability of adding or changing devices by user commands IBM Nov. 27, 1990;
US 2003046682 (A1) System and method for the automatic installation and configuration of an operating system IBM Mar. 6, 2003;
US 2003023603 (A1) Database server with enhanced management and self-configuration features ELLISON LAWRENCE J. Jan. 30, 2003;
US 2003009754 (A1) Installing supervisory process control and manufacturing software from a remote location and maintaining configuration data links in a run-time environment WONDERWARE CORP Jan. 9, 2003;
US 2002178233 (A1) Method and apparatus for the automatic migration of applications and their associated data and configuration files IBM Nov. 28, 2002;
US 2002112232 (A1) System and process for building host computers REAM JAMES A. Aug. 15, 2002;
U.S. Pat. No. 6,801,937 (B1) Method, system and program products for defining nodes to a cluster IBM Oct. 5, 2004;
U.S. Pat. No. 6,289,382 (B1) System, method and article of manufacture for a globally addressable interface in a communication services patterns environment ANDERSEN CONSULTING LLP Sep. 11, 2001;
U.S. Pat. No. 6,202,149 (B1) Automated application fail-over for coordinating applications with DBMS availability NCR CORP Mar. 13, 2001;
U.S. Pat. No. 6,173,420 (B1) Method and apparatus for fail safe configuration ORACLE CORP Jan. 9, 2001;
US 2004139145 (A1) Method and apparatus for scalable distributed storage BAR-OR GIGY Jul. 15, 2004;

In U.S. Pat. No. 7,698,391 Paliwal, et al. Apr. 13, 2010 Performing a provisioning operation associated with a software application on a subset of the nodes on which the software application is to operate assumes that application deployment architecture provides the capability to independently invoke different phases of an operation associated with an application, thereby progressively deploying the application across a network of peer nodes and providing fault tolerance. Therefore, applications are easier to deploy on the network of nodes, the deployment process is less error prone, and remediation of deployment errors is simpler than with prior approaches. Tasks constituent to phases of a deployment process are schedulable rather than completely automated and outside the control of the administrator, and are schedulable on a subset of the nodes rather than only on the entire network of nodes. U.S. Pat. No. 7,340,739 Alam, Mar. 4, 2008 Automatic configuration of a server assumes that computer system and program product for building a server according to specifications. There are a multiplicity of program objects to install a respective multiplicity of programs on the server. First program instructions determine a plurality of the program objects, which currently have prerequisite software and parameters for their respective applications. Second program instructions concurrently invoke the plurality of program objects. At least one of the plurality of program objects, after execution, invokes another of the program objects, supplying a prerequisite parameter for the other program object.

In U.S. Pat. No. 7,971,187 (B2) Configurable software stack MICROSOFT CORP Jun. 28, 2011; U.S. Pat. No. 7,873,940 (B2) Providing packages for configuring software stacks MICROSOFT CORP Jan. 18, 2011 also develops idea on improving system “PC—Software—Network”.

These applications and patents disclosing the components of a system unit and its operation with the network; however, reduced to working in a computer's network or another computer device with other devices, such as smartphones, servers. In this case the stationary personal computers have good functional characteristics, but not smartphones, mobile personal computers are not always satisfy user with provided features and long battery life. Services through the network from a third party is not always safe.

Accordingly, there is a need for a computer that can function with network, has mobility and capability of stationary PCs, long period of work charging the battery as well as sophisticated security system.

### SUMMARY OF THE DISCLOSURE

The proposed personal computer is created from information input, output, storage, processing units, network devices, as well as a preinstalled operating system. Each unit is supplemented by devices and software enabling the units to go online to the network, be registered and working in it, for example, to assign each IP address in the Internet or in the mobile communication prior to starting computer's work. The units can form a combination of any number of units with assignment of IP address does not match the IP address of any unit to combination of units. To generate computer units or combinations of units links between themselves are established. This is ensured by additional software before starting the operating system. When connecting units in combination IP address of the user-selectable units are registered in the network or at least one shared IP address of combination is registered in the network. The information storage and processing units should be preferably made stationary, and information input and output units should be mobile.

For example, combination of blocks of storage and processing of information is a system unit and combination of input and output blocks is a touch screen monitor. After booting the operating system, network, units, or combinations thereof, and IP addresses of blocks in the network form a running computer, in which network performs the functions of data—cable between units or combination of units. The computer registers its IP address that does not match the IP address of units and combinations of units in the network. Before registration of IP address in the network the computer units, combination of units, pre-installed software, as well as the IP addresses of units and combination of units are not available for third-party devices and programs over the network. After registration of IP address of the computer in the network an access mode is user-defined.

Thus, the network is used twice: for registration of units and organization of units' communication prior to the commencement of operation of the computer and for the operation of the computer over the network.

In turn, the computer starts to work online without registration of own IP address in the network while remaining hidden for third-party network devices and programs, and with the registration of the IP address the computer operates over the network in a certain way.

### BRIEF DESCRIPTION OF THE DRAWINGS

The following figures depict certain embodiments, in which like reference numerals refer to like elements. These depicted embodiments are to be understood as illustrative of the disclosure and not as limiting in any way.

FIG. 1 illustrates all units disconnected and turned off.

FIG. 2 illustrates one unit registered on the network.

FIG. 3 illustrates two units registered on the network.

FIG. 4 illustrates all units registered on the network.

FIG. 5 illustrates all units connected through the network, computer is generated.

FIG. 6 illustrates generated computer registers on the network.

FIG. 7 illustrates collaboration of generated computers with peripheral devices through the network.

FIG. 8 Illustrates combination of formed units.

FIG. 9 illustrates registration of combined units on the network.

FIG. 10 illustrates registration of unit and combination of units on the network.

FIG. 11 illustrates generation of a computer with use of combined units.

FIG. 12 illustrates computer with combination of units registers on the network.

FIG. 13 illustrates computer with combined unit performs task with external peripheral.

FIG. 14 illustrates generation and registration on the network with two computers, with a single mutual combined unit.

FIG. 15 illustrates algorithm of generation and computer operation.

### DETAILED DESCRIPTION OF THE DRAWINGS

Usefulness and reality of creating computer out of units, pre-registered online is proved as follows.

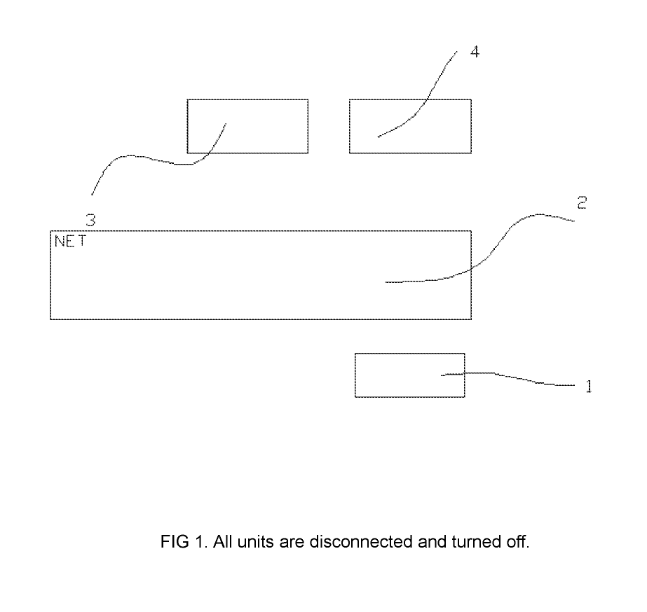

The initial state of the objects—information input, output, storage, processing units and network are shown in FIG. 1.

FIG. 1 illustrates that all blocks are disconnected and turned off.

Indicate combination of information input and output units 1, network 2, information storage unit 3, information processing unit 4.

The position, illustrated in FIG. 1, corresponds to the “all off” status. Between combination of information input and output unit 1, the information storage unit 3, information processing unit 4 and network 2 there is no connection. The combination of information input and output unit 1, information storage unit 3, information processing unit 4 do not meet the requirement of usefulness by 35 USC § 101 since individually are useless devices for the user. Running computer does not exist.

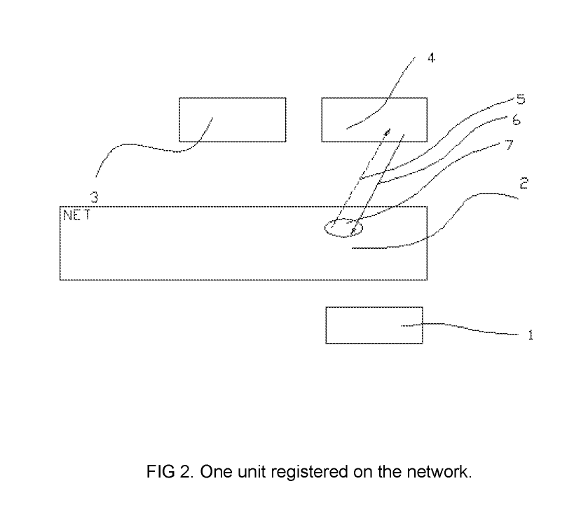

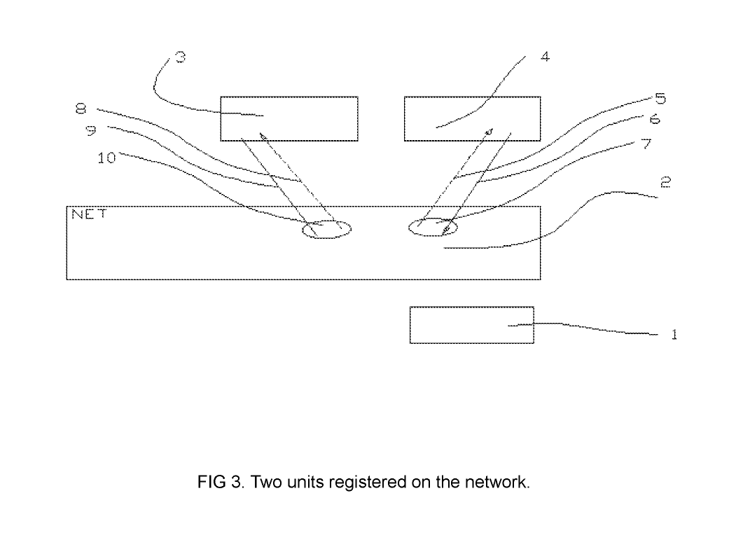

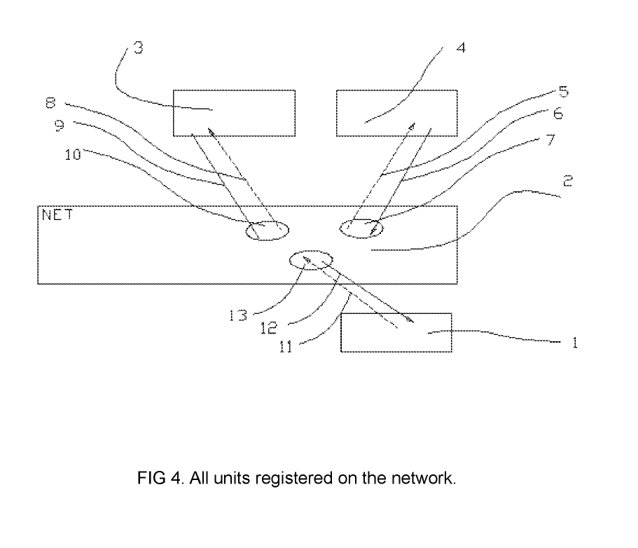

However, combination of information input and output unit 1, the information storage unit 3, information processing unit 4 includes additional devices and software that allow everyone registering online over the network 2 such as the Internet or mobile communication. Combination of information input and output unit 1, information storage unit 3, information processing unit 4 can do registration and status of communication with network 2 independently. This state is illustrated in the FIG. 2, FIG. 3, and FIG. 4.

On FIG. 2 one block registered on the network. In addition to FIG. 1 illustrates links 5 and 6 of information processing unit 4 with IP address 7of information processing unit 4 in the network 2.

State of information processing unit 4 corresponds to the situation where the user switched on power supply in stationary information processing unit 4.

However, the operating system start-up does not occur. According to the claims of applicants only additional devices and programs start operating; information processing unit 4 is registered online in the network 2 and goes into standby mode for communication with combination of input and output unit 1, information storage unit 3. Information processing unit 4 will be unavailable to any other devices connected directly or over the network 2. Running computer still does not exist.

On FIG. 3 two blocks registered on the network. In addition to FIG. 2 illustrates the links and connections 8 and 9 of information storage unit 3 with IP address 10 of information storage unit 3 in the network 2.

State of the data storage unit 3 corresponds to the situation where the user switched on power supply at a stationary information storage unit 3. According to the claims of the applicants only additional devices and programs start operating; the information storage unit 3 is registered online in the network 2 and goes into standby mode for communication with combination of input and output unit 1, information processing unit 4. Information storage unit 3 will be unavailable to any other devices connected directly or over the network 2. Running computer still does not exist.

On FIG. 4 all blocks registered on the network. Image illustrates the links and connection 11 and 12 of information input and output unit 1 with IP address 13 of information input and output unit 1 in the network 2.

State of the combination of information input and output blocks 1 corresponds to the situation where the user switched on power supply at a mobile combination of information input and output units 1. According to the claims of the applicants only additional devices and programs start operating in combination of information input and output units 1 is registered online in the network 2 and goes into standby mode for a signal from the user to create a computer. Combination of input and output unit 1 will be unavailable to any other devices connected directly or over the network 2. Running computer still does not exist but all its units have been registered online in the network.

Physically links 5, 6, 8, 9, 11, 12 with IP addresses 7, 10, 13 in the network 2 can performed with SIM cards when using the cellular network or devices provided by Internet service providers.

Online registration of combination of information input and output units 1 information storage unit 3, information processing unit 4 in the network 2 has some features.

Only the user of combination of information input and output units 1 with access rights may apply to the IP address 7of information processing unit 4. The right of access can be arranged in a certain way on physical parameters—combination of information input and output units 1 (or multiple predefined information input and output units), or passwords that are pre specified for information processing unit 4.

Only information processing unit 4 can address the IP address 10 of information storage unit 3 in the process of creating or working on the computer.

Nobody cannot address the IP address 13 of combinations of information input and output units 1.

Thus, registered online in the network 2 combination of information input and output units 1, the information storage unit 3, information processing unit 4 still cannot perform useful actions, they are waiting for user commands to create computer in the network 2. The running computer still does not exist.

Only combination of information input and output units 1 in the network 2 is in a state of communication, units 3, 4 are prepared to implement the following limited possible actions:
by user command remote combination of information input and output units 1 is applied to information processing unit 4 over the network 2 and instructs on the establishment of a computer;
by user command to disable combination of information input and output units 1 and terminate its connection with the network 2;
by user command to disable the connection of information processing unit 4 or data storage unit 3;
other commands, achievable without creating a computer, for example: command from combination of information input and output units 1 on the destruction of information or physical destruction of devices at the information storage unit 3 and information processing unit 4; disabling of the information storage unit 3 and information processing unit 4 when they detect unauthorized possession, etc.

Limited capacity to implement the actions prior to the beginning of work of computer is intentional and stems from a desire for secrecy and security of information. So combination of information input and output unit 1, the information storage unit 3, information processing unit 4 are supplemented by devices and software with limited capabilities. These additional features only allow logging in to the network 2 and communicate with each other in the network 2, but did not give combination of information input and output unit 1, information storage unit 3, information processing unit 4 the capabilities that they typically have when operating as a part of a running computer. And also without capacities of independent remote computing device running under control of software or any mobile device over the network.

In other words, without anything that fits concepts and methods concerning visualization of GUIs on network devices since at this stage there is no computer device to which one can refer and apply concepts and methods regarding GUIs visualization on network devices.

This is possible since the IP addresses 7, 10 and 13 and combinations of information input and output unit 1, information storage unit 3, information processing unit 4 are closed for access of other devices and programs. Therefore, additional devices and software are not able to allow combination of information input and output unit 1, the information storage unit 3, information processing unit 4 contacting the hosting agent, be under control of hypervisor, represent the client agent, or connect the thin client and the like. These features appear only after the commencement of the operation of a computer over the network 2.

The objects illustrated in FIGS. 2-4 and claimed lead to new network architecture, protocols, IP addresses, software etc., have know-how. In fact, this is a new trend and business organization in IT field.

After the execution of situation on FIG. 4 combination of information input and output unit 1, the information storage unit 3, information processing unit 4 each are independently registered online in the network 2.

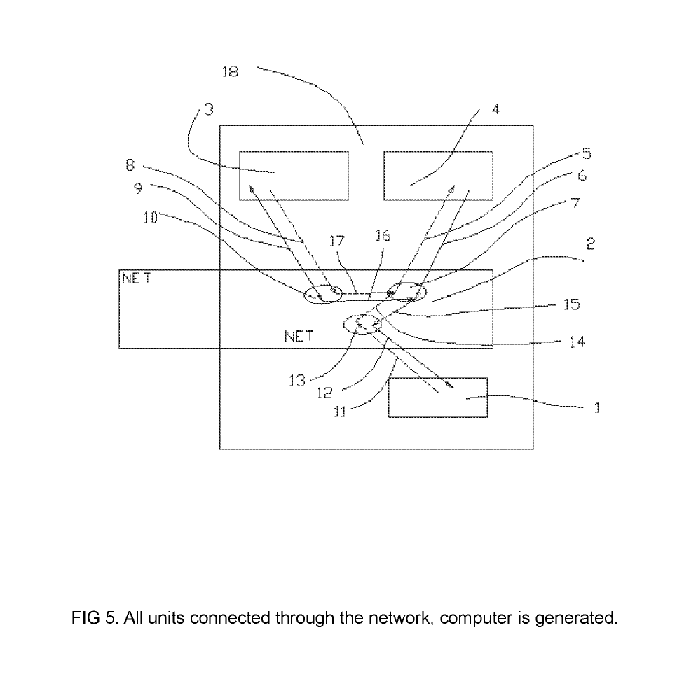

The computer's generation process is explained on FIG. 5. Here it illustrates that all blocks connected through the network and computer is generated. By using combination of information input and output unit 1 user gives the command to start up a computer. By using additional software communication of IP address 13 of combination of information input and output unit 1 is arranged with IP address 7 of information processing unit 4.

Information about IP address 7 should preferably be entered into command for establishing linkage 14 directly to the user. This reduces the possibility of starting a computer in automatic mode during unauthorized access to a combination of information input and output unit 1.

Further information processing unit 4 in the network 2 establishes links 16 and 17 from IP address 7 of information processing unit 4 with IP address 10 of information storage unit 3.

Then command from combination of information input and output unit 1 goes to information processing unit 4 on launching the operating system preinstalled on it. The information processing unit 4 launches a preinstalled operating system, performs all configuration steps for all hardware properly. In doing so, information processing unit 4 sets link 15 from IP address 7 of information processing unit 4 with IP address 13 of combination of information input and output unit 1 via the network 2.

Thus, only after starting up the preinstalled operating system IP address 13 of combination of information input and output units 1 becomes available for mutual transferring the information between combination of information input and output units 1 and information processing unit 4 over the network 2.

On traffic through the network 2 transfer of information for visualization on combination of information input and output units 1 for operating system interface is provided. Since visualization of the operating system interface at combination of information input and output units 1 the running personal computer 18 appears. The rectangle that indicates the computer 18 includes combination of information input and output units 1, information storage unit 3, information processing unit 4 and network 2 as data-cables.

Links 5, 6, 8, 9, 11, 12, 14 are established by additional devices and additional software on claims of the applicants. Prior to starting the operating system on links 5, 6, 8, 9, 11, 12, 14, only some coded commands described earlier may be transferred.

After starting up the operating system and establishing link 15 by the information processing unit 4 the links 5, 6, 8.9, 11, 12, 14, 15 are controlled further by computer 18, not by additional devices and programs in combination of information input and output units 1, information storage unit 3, information processing unit 4. The network 2 physically becomes a part of computer 18—it plays the role of a data-cable between the units.

A particularly important and new is that the computer with preliminary registered in the network units works in the network and the computer itself does not have any online registration in the network. Therefore, it cannot be accessed.

Thus the user being remotely can use computer 18, having only combination of information input and output units 1, which can be performed in the form of a monitor with touchscreen and additional devices and software according to claims of the applicants for independent online registration over the network.

At the same time, the information processing unit 4 that had started the pre-installed operating system does not use any software for combination of information input and output unit 1. Only coded command on creating computer 18 is given with combination of information input and output unit 1. Any device of software for remote access to computing devices, such as Remote Desktop Protocol (RDP) or NX, is not used. The use is impossible since the units individually are not healthy computing devices.

The principles, on which hosting agent, hypervisor, client agent, thin client and other devices operate also not used for the same reason.

The created from pre-registered online in the network 2 PC 18 would be useful for a wide range of users, because it presents essential advantages.

First and foremost is the security and protection of information. Stationary information storage unit 3 and information processing unit 4 can be well protected against unauthorized access.

It is easier to configure stationary information storage units 3 and information processing units 4 under user profile with very high capacity and practically unlimited power consumption.

Consequently, this reduces the need to store information and process it on cloud technologies, which is vulnerable for unauthorized access, including Internet service provider.

In the event of theft of mobile combination of input and output units 1 information risk of losing information is substantially less since the procedure for starting a computer 18 over the network 2 is closed from the third-party hardware and software by configuration of computer out of pre-registered online in the network units, and the combination of information input and output units 1 contains no information about IP address 7 of information processing unit 4.

The proposed computer composed of pre-registration online units is useful for special machines, especially those for which it is important not to have computing and software devices in the machine. In case of unauthorized capture of machine the captured information input and output units will be useless.

A computer comprising pre-registration online units can also be useful to developers, whose information is strictly confidential. Operation outside the protected areas is possible, for example when traveling without fear of stealing of computer, software and data.

A major advantage is the ability to use all of the information and software in information storage unit 3 and information processing unit 4. In such volume and with such software that is unreachable for the mobile computer.

Battery life for combination of information input and output units 1 is significantly increased as energy-intensive procedures are performed by stationary storage information unit 3 and information processing unit 4, and the remote combination of information input and output units 1 only gives commands and visualize the information.

Another advantage is that the performance of the personal computer 18 is limited to level of network 2 and hardware capabilities in information storage unit 3 and processing of information unit 4. In stationary units they are very huge, for example, memory volume, computing capabilities and number of CPUs, capabilities for cooling components, power consumption, etc.

When powerful information storage unit 3 and information processing unit 4 are installed at home, family members can use only remote combination of information input and output units 1 each, reducing overall costs.

The proposed computer 18 is useful due to its advantages in the exhibitions and presentations, during travel, for special services, families, video players, etc. The use of computer on the application form of the applicants appear to be of special benefits for the people that use freelancing and are users of the programs with large amounts of processed information—to journalists, Web and graphic designers, engineers.

Further the computer 18 with pre-registered online in the network units can be registered online in the network 2 in a certain way.

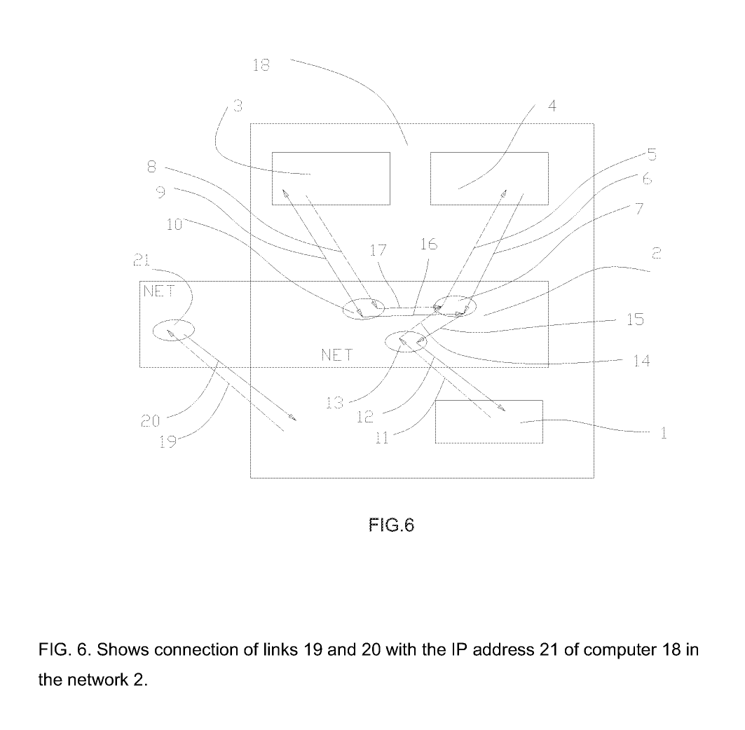

This process is illustrated in FIG. 6, where generated computer registers on the network. Computer 18 and network 2 make links 19 and 20 with the IP address 21 of computer 18 in the network 2. Thus, computer 18 uses several IP addresses in the network 2: three private and closed for external access IP address 7, 10, 13 of units 1, 3, 4 and one open for external access the IP address 21 of computer 18.

Thus, operating in the network 2 computer 18 consisting of pre-registered online network 2 units is unavailable for any third-party devices and software programs prior to registration online in the network 2 IP addresses 21 of computer 18, and if to exclude the network 2, then the computer 18 according to application of the applicants disappears, only the fragmented units that are not computing devices remain.

In the future the computer 18 from pre-registered online in the network 2 units can occur in a well-known manner.

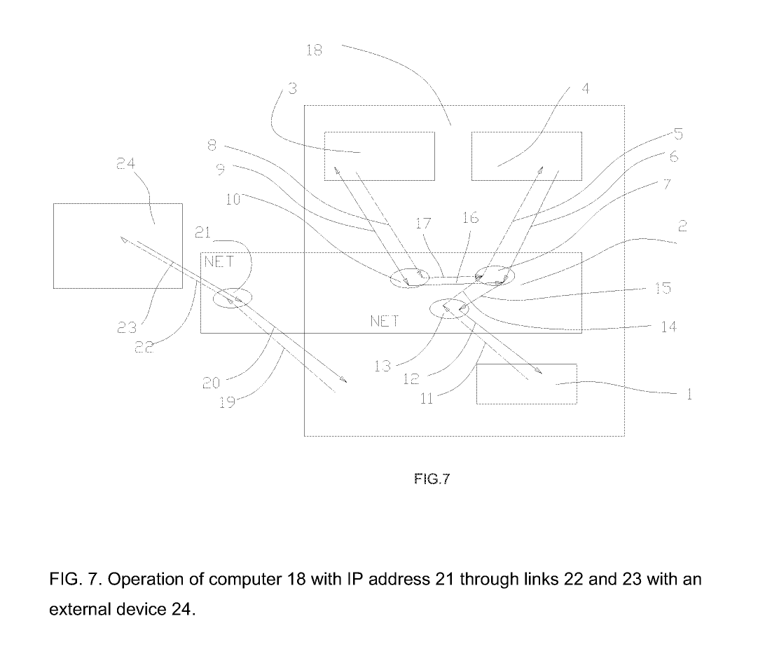

For example, FIG. 7 illustrates the work of generated computer with external devices on the network. Executes operation of computer 18 with IP address 21 via links 22 and 23 with an external device 24.

The computer 18 that has registered IP address 21 can operate with the hosting agent, hypervisor, client agent, thin client and other programs and devices.

Computer according to the applicants' claim may contain combinations of units that are registered online independently in the network.

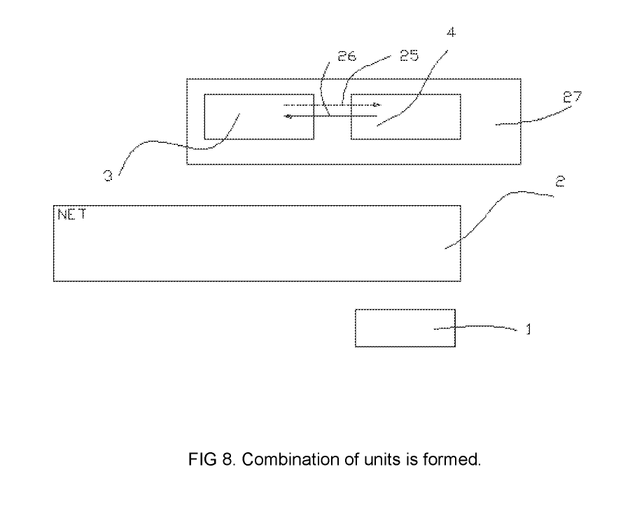

Formation of combinations of units is illustrated in FIG. 8.

Information storage unit 3 and information processing unit 4 are connected directly to each other by links 25 and 26. This can be done with a cable or wirelessly, resulting in a combination of units, in this case a system unit 27.

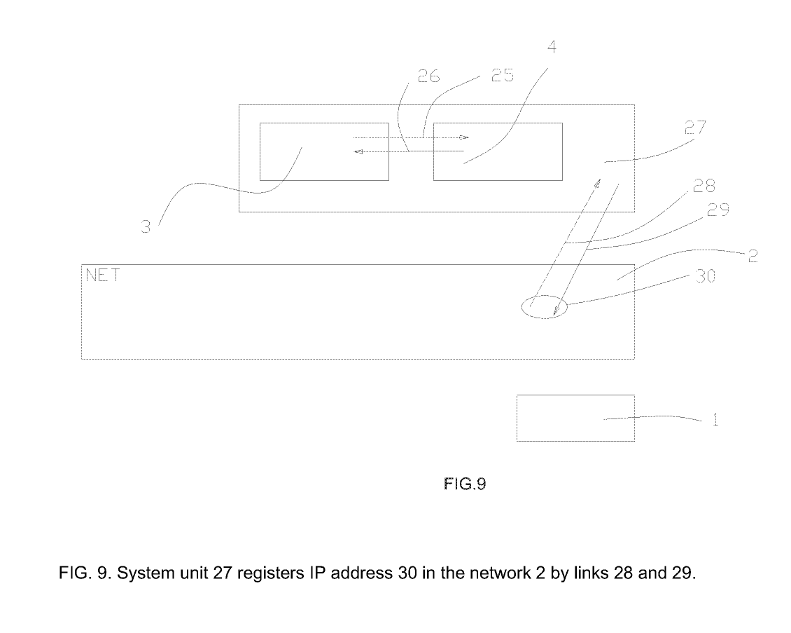

Further on, FIG. 9 demonstrates registration on the network of combination of units. System unit 27 registers IP address 30 via links 28 and 29 in the network 2. In principle any combination of units is able to surf the network 2 as a new object and be part of a computer.

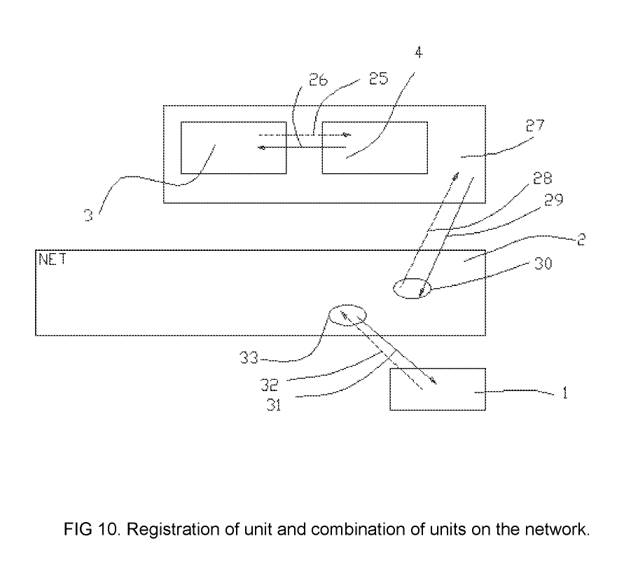

Hereinafter FIG. 10 illustrates registration on the network of combinations of units. Shown option of implementation for occurrence of combinations of units in the computer with new IP addresses.

User enabled the combination of information input and output units 1, hereinafter by above described method on links 31 and 32 new IP address 33 for combinations of information input and output units 1 B in the network 2 is registered.

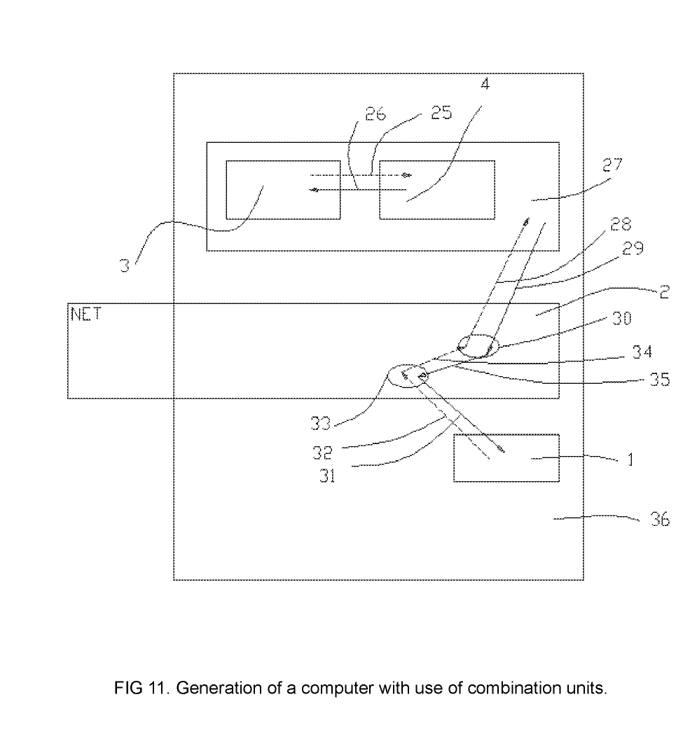

The computer's generation process is illustrated in FIG. 11. It shows generation of a computer with the use of a combinations of units. By command from combination of information input and output unit 1 links 34 and 35 between IP address 30 of system unit 27 and IP address 33 of combinations of information input and output unit 1 are established. Then the system unit 27 launches a preinstalled operating system, visualizes the interface of operating system and computer 36 is generated.

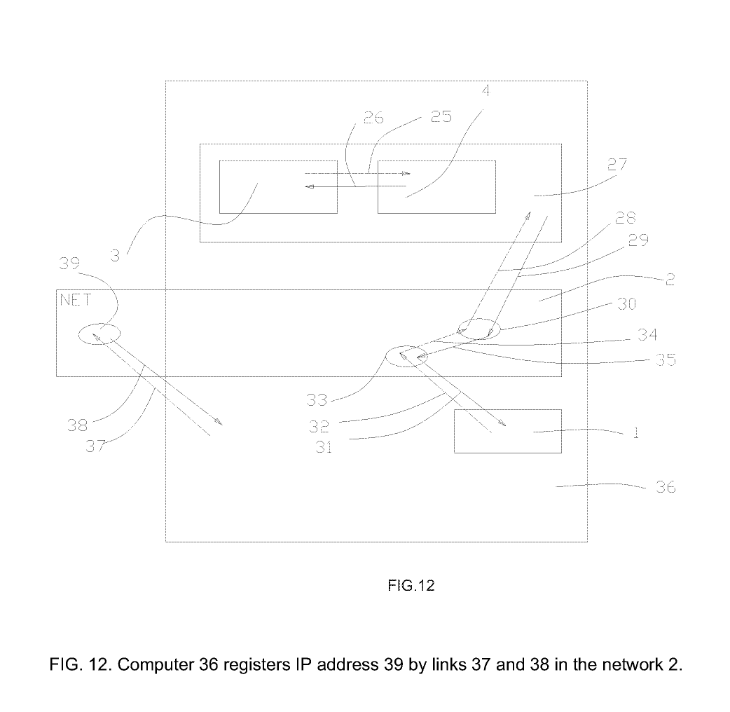

FIG. 12 illustrates online registration of IP addresses links 39 via links 37 38 in the network 2 of computer 36.

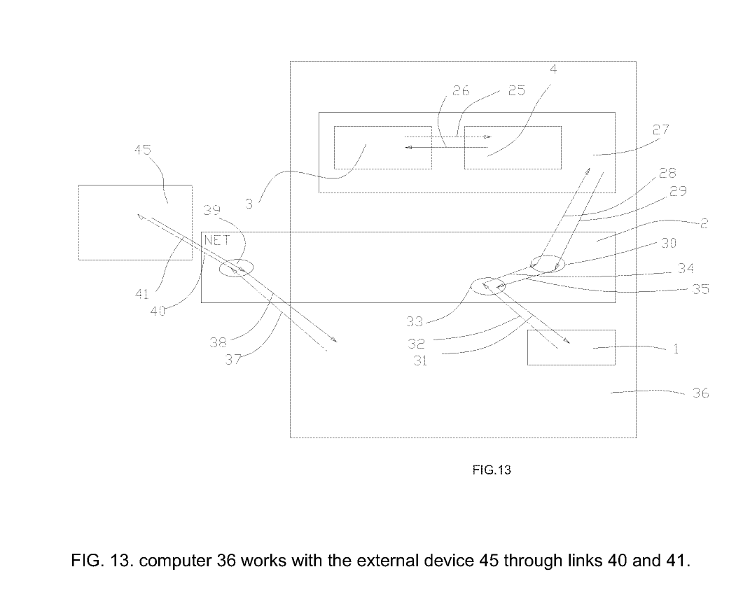

FIG. 13 illustrates operation of computer generated from combination of units on the network with external device. Computer 36 with an external device 42 operates through links 40 and 41.

Similarly, by using two described methods, computer consisting of any number units and their combinations, pre-registered online in the network may be generated.

The claimed computer 18 has the added property due to the previously described possibilities of combination of information input and output unit 1. As the combination of information input and output units 1 represents a very limited by functionality object, in its capacity the devices, functioning in the network, for example, car monitors, TV sets can be used to create computer 18. According to the applicants' claim such devices must be supplemented with the ability to register IP address, enter the commands and the IP address of information processing unit.

The claimed properties of computer 18 also minimize costs while creating multiple computers over a network for multiple users.

In the computer various combinations of quantities and links of pre-registered online in the network units and their combinations, as well as the simultaneous occurrence of pre-registered online units and their combinations in the composition of multiple computers may be.

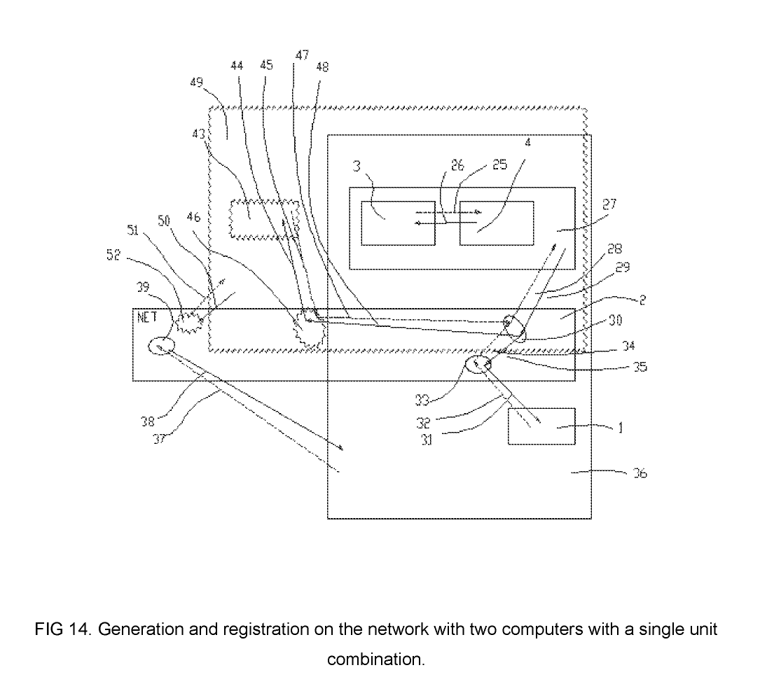

So in the development of the situation in FIGS. 12-13 and FIG. 14 illustrates generation and registration on the network of two computers with single joint combination of units. Given example of occurrence of one system block 27, consisting of one combination of information storage unit 3 and information processing unit 4, with two combinations of input and output units-1 and 43 in two computers.

By user's command the combination of information input and output units 43 logs on its IP address 46 through links 44 and 45 in the network 2. With IP address 46 combination of information input and output units 43 connects with the IP address 30 of the system unit 27 of combination of information storage unit 3 and information processing unit 4 via link 47.

The working operating system of computer 36 sets link 48 and interface of operating system is displayed on combination of information input and output units 43, i.e. another computer 49 of the second user, indicated by a rectangle of zig-zag lines is generated.

If computer 36 was not generated all actions to generate computer 49 first are similar to those described earlier for starting PC 18 or 36.

Further computer 49 registers online IP address 52 via links 50 and 51 in the network 2.

As per the Applicants' claim, the blocks can also independently generate multiple computers without using the first generated computer, for instance, running the operating systems each time for each newly generated computer.

Thus, two or more users can use computers, containing common previously registered in the network units, but computers are logged on in the network by different IP addresses.

These computers from units and network are suitable for families and business.

The following combinations of quantities and links of units registered online in the network 2 to serve as computers are possible:
one information input unit, one information output unit, or one combination of information input and output units and more than one information storage unit, more than one information processing unit, or more than one combination of information storage and processing units are registered in the network;
more than one information input unit, more than one information output unit, or more than one combination of information input and output units and one information storage unit, one information processing unit, or one combination of information storage and processing units are registered in the network;
more than one information input unit, more than one information output unit, or more than one combination of information input and output units and more than one information storage unit, more than one information processing unit, or more than one combination of information storage and processing units, and in any combination and in any number of information input, output, storage and processing units are registered in the network.

The peculiarity of this diversity of options for occurrences of online registered units as a part of computers is the number of private IP addresses for units and their combinations.

This property increases security when creating and operating the computers.

Important opportunity to protect the computer may be ensured during gathering and sale of information input and output units, information storage units, information processing units. To do this, the order of access to additional devices and software of information input, output, storage and processing units or combinations of them should be specified. For example, to allow access to changes when connecting the units by data-cable, wirelessly when gathering for sale or after registration of the IP addresses of all units and their combinations in the network. In this case, subsequent registration of IP address of the computer in the network blocks the possibility of changing the additional devices and software blocks the information input, output, storage and processing units or combinations of thereof.

For the convenience of the user, information input, output, storage and processing units or combinations thereof are also made with the possibility of functioning of external plug-in devices such as a printer or a Flash card only after starting the computer.

The security of the computer may be significantly increased by completing the registration of information input, output, storage and processing units or their combinations in more than one network.

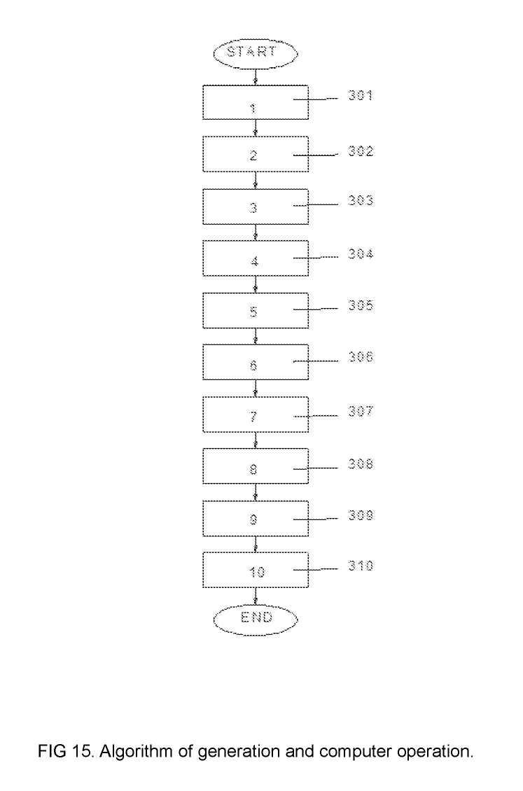

One possible algorithm alternative for registration of units and their combinations in the network to serve the computer is illustrated in FIG. 15.

Algorithm of generation and computer operation as well as sequence of steps for registration of units and their combinations for incorporation into the computer and peripherals and action of additional devices and programs in the units when registering the units in the network and starting up the computer is illustrated in FIG. 15.

The initial step is 301. Meanwhile combination of information input and output units 1, information storage unit 3 and information processing unit 4 are off.

Status: all off, connection of all units with network 2 is not available, running computer does not exist.

In step 302 the user enables power supply on the information processing unit 4 and data storage block 3. Additional devices and additional software for information processing unit 4 and information storage unit 3 are activated. Running additional devices and additional software for information processing unit 4 and information storage unit 3 make registration of information processing unit 4 and information storage unit 3 in the network 2.

Status: waiting for connection of information processing unit 4 with combination of information input and output units 1; combination of information input and output units 1 is turned off.

In step 303 the user switched on power for combination of information input and output unit 1.

The additional devices and additional software for combination of information input and output unit 1 are activated.

The running additional devices and additional software for combination of information input and output unit 1 make registration of combination of information input and output unit 1 in the network 2.

Status: waiting for connection of information processing unit 4 with combination of information input and output unit 1, waiting for the user command on computer startup by combination of information input and output unit 1.

In step 304 the user enters IP address of information processing unit 4 into combination of information input and output blocks 1 that may be command on starting up the computer 18. Combination of information input and output units 1 sets link 14 in FIG. 5 of combination of information input and output unit 1 with information processing unit 4 by additional devices and additional software in the network 2.

Status: linking IP address of combination of information input and output units 1 and IP address of information processing unit 4.

In step 305 the information processing unit 4 starts the preloaded operating system, links 16 and 17 in FIG. 5 to communicate with information storage unit 3 are established, link 15 in FIG. 5 with combination of information input and output units 1 is set up. Visualization of combination of information input and output units 1 for interface of the operating system is implemented. Links 5, 6, 8, 9, 11, 12, 14, 15, 16, 17 go out of control by additional devices and additional software and pass under the control of the loaded operating system over the network 2. Network 2 is used for the first time in the composition of computer 18 and performs the role of data—cables.

Status: working in the network without online registration of PC 18 in the network.

In step 306 PC 18 logs in the network 2 by user command.

Status: IP address 21 of PC 18 in the network 2, readiness of PC 18 for the network connection to the external device 24.

In step 307 work of user of PC 18 with an external device 24 in the network 2 is performed. The network 2 is used for the second time for operation of the computer 18 in the network 2.

Status—PC 18 operating in a certain way over the network 2.

In step 308 the user instructs information processing unit 4 with combination of information input and output units 1 on switching off PC 18. Information processing unit 4 switches off the operating system. All links are moving under control of additional devices and additional software for units. Running computer 18 does not exist.

Status: the computer is turned off; all the units are registered online in the network, waiting for user commands.

In step 309 connection of combinations of information input and output units 1 with network 2 is disabled.

Status: information processing unit 4 and information storage unit 3—registration in the network 2 and waiting for connection and commands from combination of information input and output units 1 under control of additional devices and additional software; combination of information input and output units 1—registeration online in the network 2 is unavailable, waiting for the user commands.

In step 310 the power supply for combination of information input and output units 1 is switched off.

Status: information processing unit 4 and information storage unit 3—registration in the network 2 and waiting for connection and commands from combination of information input and output units 1 under control of additional devices and software; combination of information input and output units 1—off.

Other alternatives of algorithms are possible according to claims of the applicants.

Their formation occurs the same way as described one and in accordance with claims. It should be understood that, in accordance with claims the user can independently generate convenient algorithm of work.

1. Personal computer contains units for input, output, storage, information processing, network devices, as well as preinstalled software, units are implemented as stationary or mobile and each unit is additionally equipped with devices and software such that each unit independently has the ability to register and work in the network, for example by assigning IP address on the Internet or numbers in mobile communication for each unit, with possibility of connection of units through the network only between themselves in any combination of units and any number of units and combination of units register at least one shared IP addresses in the network, meanwhile, generated by the units or their combinations and IP addresses in the network, the computer runs in the network through an IP address, that does not match the IP address of units and their combinations, and prior to registration of IP address of the computer configured by units and combinations of units in the network an access of third-party facilities and programs to the computer, units and combinations of units directly and from the network is not possible.

2. Personal computer on claim 1 according to which information input and output means is any device, exchanging commands and information with the user and capable to register independently online in the network.

3. Personal computer on claim 1 according to which one information input unit, one information output unit, or one combination of information input and output units and more than one information storage unit, more than one information processing unit, or more than one combination of information storage and processing units are registered in the network.

4. Personal computer on claim 1 according to which more than one information input unit, more than one information output unit, or more than one combination of information input and output units and one information storage unit, one information processing unit, or combination of information storage and processing units are registered in the network.

5. Personal computer on claim 1 according to which more than one unit of information input unit, more than one information output unit, or more than one combination of information input and output units and more than one information storage unit, more than one information processing unit, or more than one combination of information storage and processing units are registered in a network, and in any combination and in any number of information input, output, storage and processing units.

6. Personal computer on claim 1 according to which additional devices and software of information input, output, storage and processing units or their combinations available to changes when they are connected by data-cable, wirelessly or after registration of IP addresses of all units and their combinations in the network, and registration of IP network address of a computer blocks the possibility of changing the additional devices and software for information input, output, storage and processing units or their combination.

7. Personal computer on claim 1 according to which information input, output, storage and processing units or combinations thereof are made with the possibility of functioning of external plug-in devices such as a printer or Flash cards only after starting the operating system on the computer.

8. Personal computer on claim 1 according to which registration of information input, output, storage and processing units or their combinations is performed in more than one network.
